(19) United States
(12) Patent Application Publication
(10) Pub. No.: US 2006/0191142 A1
(43) Pub. Date: Aug. 31, 2006

(54) Control mechanism for controlling width of two cutting blades

(76) Inventor: Titan Jou, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/066,473

(22) Filed: Feb. 28, 2005

(51) Int. Cl. B26B 13/00

(52) U.S. Cl. 30/262

(57) ABSTRACT

A pair of scissors includes a first part which is pivotably connected to a second part. A stop extends from an inside of the second part. A control member rotatably extends through a connection hole in the first part and includes a plurality of engaging surfaces which have different radial heights so that the stop is engaged with one of the engaging surfaces to set the desired width between two blades of the first and second parts.

### FIELD OF THE INVENTION

The present invention relates to a control mechanism for controlling width between two cutting blades of pruning scissors, wherein the mechanism is located between the two handles and includes multiple controlling stages.

### BACKGROUND OF THE INVENTION

A conventional pair of scissors or pruning scissors generally includes two handles which are pivotably connected with each other and two cutting blades are integrally connected to two respective ends of the handles so that when closing the two handles toward each other, the two cutting blades are moved toward each other to cut an object therebetween. A locked or control device is connected to the conventional pruning scissors to set the positions of the two blades, such as to maintain the two blades at close position. Most of the conventional control device includes many tiny parts which are assembled in a complicated way. The parts include a spring, a rack member, a pin and a ratchet member, all of which have to be assembled carefully in a small space. During assembling, the parts often jump out because of the spring and are difficult to be found. Besides, the conventional control device is exposed on outside of the scissors and might be tangled by object to be cut. The conventional control device might also be activated unintentionally.

The present invention intends to provide a control mechanism for controlling width between two cutting blades of pruning scissors, wherein the control mechanism is located between two handles so that it is not easily touched by the object to be cut and includes multiple control stages to set different widths between the two blades.

### SUMMARY OF THE INVENTION

The present invention relates to a pair of scissors which comprises a first part having a first handle and a first blade which is connected to an end of the first handle. A first pivotable hole is defined in the first part and located between the first handle and the first blade. The first part has a connection hole. A second part has a second handle and a second blade which is connected to an end of the second handle. A second pivotable hole is defined in the second part and located between the second handle and the second blade. The first and second parts are pivotably connected with each other by extending a pin through the first and second pivotable holes. The second part has a stop extending from an inside thereof. A control member rotatably extends through the connection hole and includes a plurality of engaging surfaces which have different radial heights so that the stop is engaged with one of the engaging surfaces.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a perspective view of the scissors with the two blades open wide;

FIG. 2 is an exploded view to show the scissors of the present invention;

FIG. 3 shows a perspective view of the scissors wherein the two blades are close with each other;

FIG. 4 shows the stop on the second part is engaged with the first engaging surface of the control member;

FIG. 5 shows the stop on the second part is engaged with the second engaging surface of the control member;

FIG. 6 shows that the tubular portion of the control member is a cam, and

FIG. 7 shows that the tubular portion of the control member includes three engaging surfaces.

### DETAILED DESCRIPTION OF THE PREFERRED EMBODIMENT

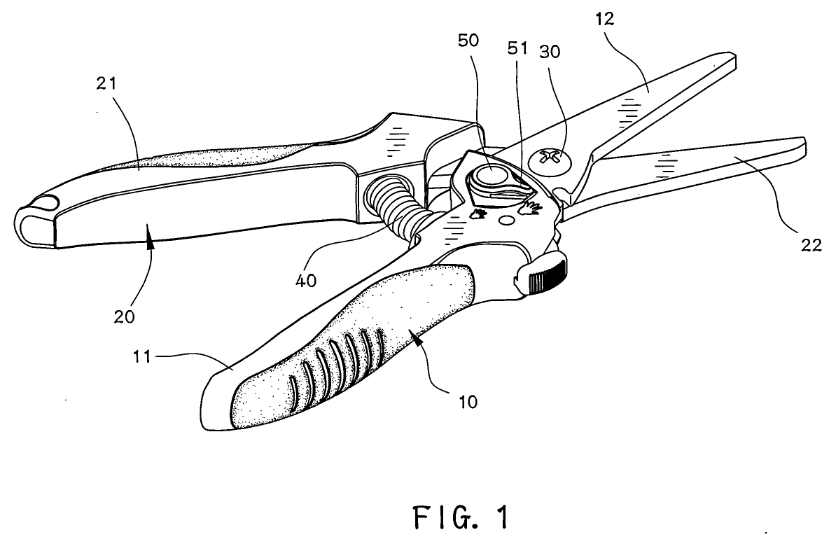

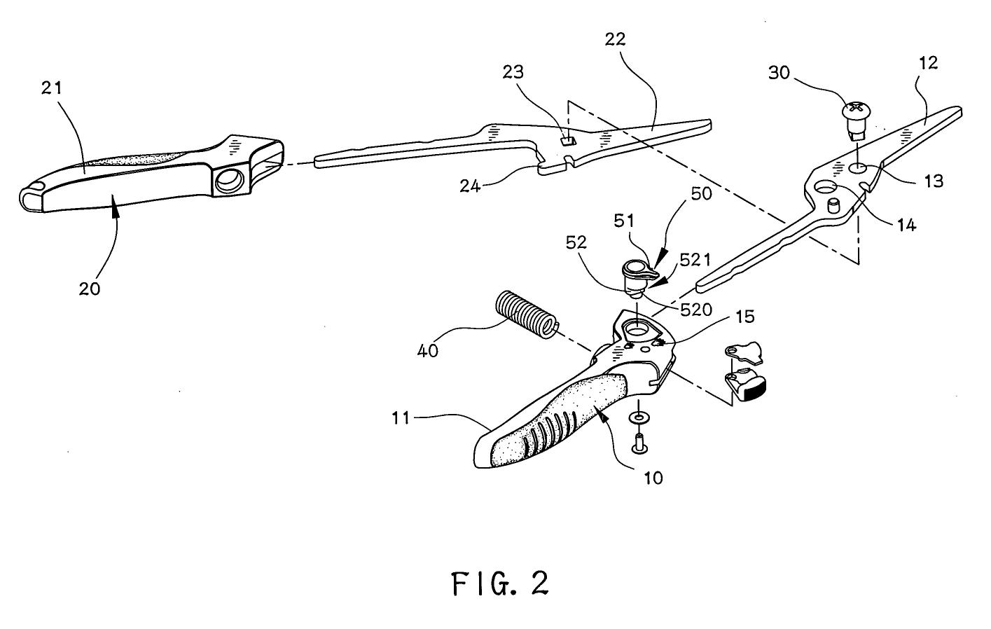

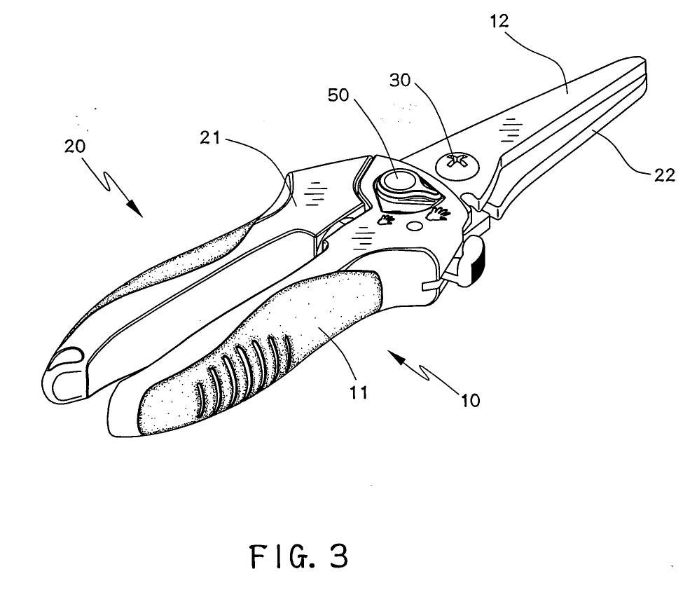

Referring to FIGS. 1 to 3, the scissors of the present invention comprises a first part 10 having a first handle 11 which can be a grip mounted to the first handle 11, and a first blade 12 which is connected to an end of the first handle 11. A first pivotable hole 13 is defined in the first part 10 and located between the first handle 11 and the first blade 12. The first part 10 has a connection hole 14 which is located close to the first handle 11 than the first pivotable hole 13.

A second part 20 has a second handle 21 which can be a grip mounted to the second handle 21, and a second blade 22 which is connected to an end of the second handle 21. A second pivotable hole 23 is defined in the second part 20 and located between the second handle 21 and the second blade 22. A pin 30 extends through the first and second pivotable holes 13, 23 so as to pivotably connect the first part 10 to the second part 20. The second part 20 has a stop 24 extending from an inside thereof and the stop 24 is located between the second pivotable hole 23 and the handle 21.

A control member 50 includes a tubular portion 52 which rotatably extends through the connection hole 14 and a lever 51 extends from a top end thereof. The top end of the control member 50 is located at a top surface of the first part 10. A plurality of indexes 15 are marked on the top surface of the first part 10 and located beside the lever 51 so that the user may switch the lever 51 to point one of the indexes 15 which shows the width to be opened between the first and second blades 12, 22. The tubular portion 52 includes a plurality of engaging surfaces defined in an outer periphery of the tubular portion 52, in this embodiment, there are two engaging surfaces 520, 521 which have different radial heights. A spring 40 is connected between the first and second handles 11, 21 so that the first and second handles 11, 21 have a tendency to open wide.

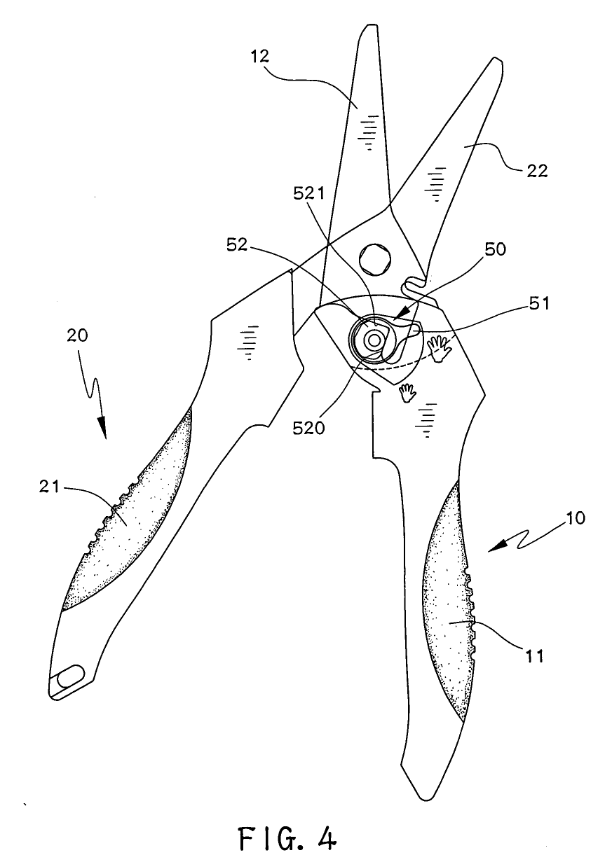

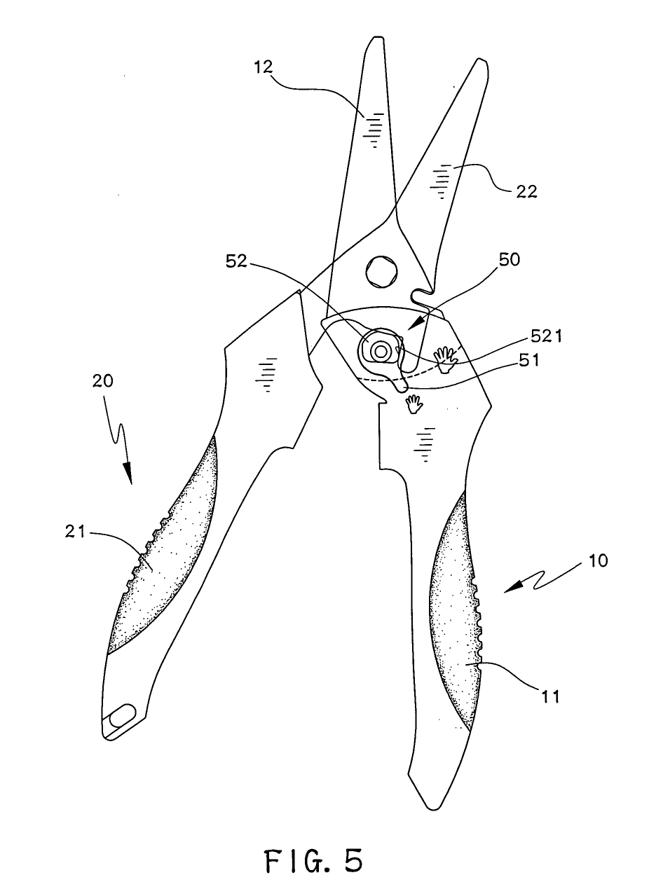

As shown in FIG. 4, when switching the lever 51 to point the index 15 which is a large hand, when releasing the first and second handle 11, 21, the stop 24 is engaged with the first engaging surface 520 which is lower than the second engaging surface 521 so that the width between the first and second blades 12, 22 is wider. As shown in FIG. 5, when switching the lever 51 to point the other index 15 which is a small hand, the stop 24 is engaged with the second engaging surface 521 which is higher than the first engaging surface 520 so that the width between the first and second blades 12, 22 is narrower. This allows the user not to operate the handles from the widest positions every time pruning flowers.

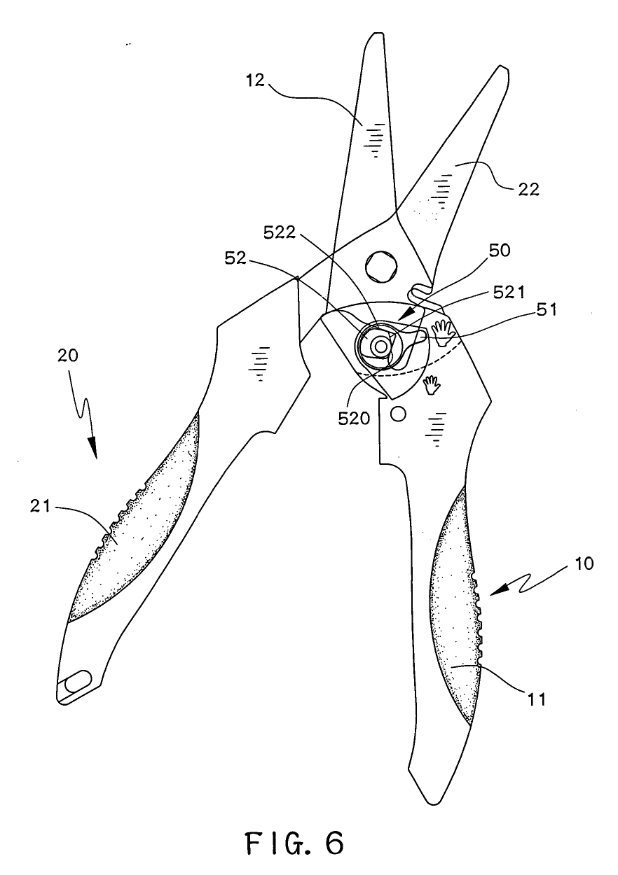

As shown in FIG. 6, the number of the engaging surfaces can be three, such as the first engaging surface 520, the second engaging surface 521 and the third engaging surface 522.

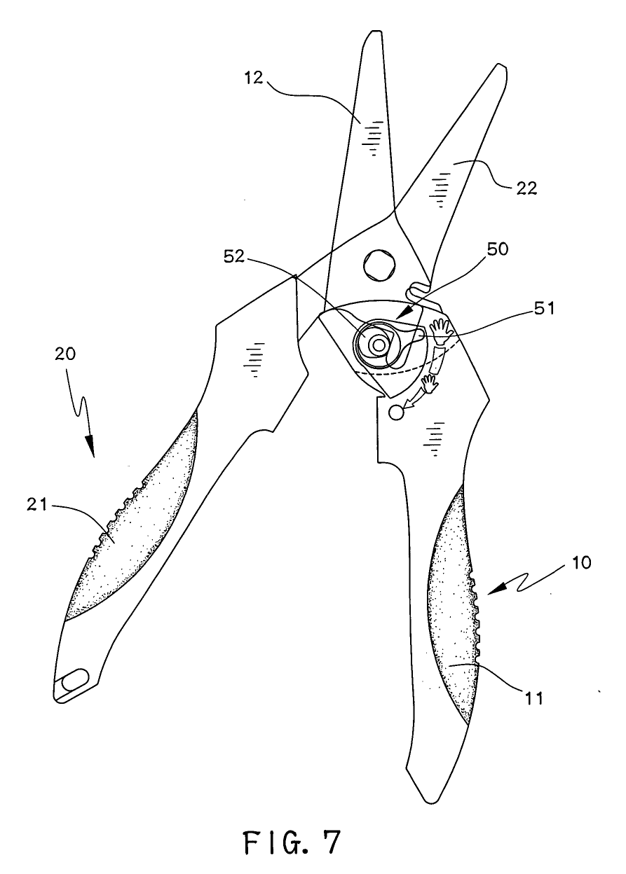

As shown in FIG. 7, the tubular portion 52 of the control member 50 can be a cam which includes continuous spiral surface with different radial heights so that the widths between the first and second blades 12, 22 can be controlled to be any desired widths.

While we have shown and described the embodiment in accordance with the present invention, it should be clear to those skilled in the art that further embodiments may be made without departing from the scope of the present invention.

What is claimed is:

1. A pair of scissors comprising:
a first part having a first handle and a first blade which is connected to an end of the first handle, a first pivotable hole defined in the first part and located between the first handle and the first blade, the first part having a connection hole;
a second part having a second handle and a second blade which is connected to an end of the second handle, a second pivotable hole defined in the second part and located between the second handle and the second blade, a pin extending through the first and second pivotable holes, the second part having a stop extending from an inside thereof, and
a control member rotatably extending through the connection hole and including a plurality of engaging surfaces which have different radial heights so that the stop is engaged with one of the engaging surfaces.

2. The scissors as claimed in claim 1, wherein the stop is located between the second pivotable hole and the handle.

3. The scissors as claimed in claim 1, wherein the control member has a lever extending from a top end thereof and the top end of the control member is located at a top surface of the first part.

4. The scissors as claimed in claim 1, wherein a spring is connected between the first and second handles.

5. The scissors as claimed in claim 1, wherein the control member includes a tubular portion which extends through the connection hole and the engaging surfaces are defined in an outer periphery of the tubular portion.

6. The scissors as claimed in claim 1 further comprising a plurality of indexes marked on the top surface of the first part and located beside the lever.

7. The scissors as claimed in claim 5, wherein the tubular portion is a cam with continuous spiral outer surface which includes multiple radial heights.
